(19) United States
(12) Patent Application Publication
(10) Pub. No.: US 2024/0422683 A1
(43) Pub. Date: Dec. 19, 2024

(54) WIRELESS RECEIVER DEVICE, DATA PROCESSING METHOD THEREOF, AND WIRELESS COMMUNICATION SYSTEM

(71) Applicant: Realtek Semiconductor Corporation, Hsinchu (TW)

(72) Inventors: Hsin-Yu KUO, Hsinchu (TW); Chi-Mao LEE, Hsinchu (TW); Hsin-Chih HUANG, Hsinchu (TW)

(21) Appl. No.: 18/741,777

(22) Filed: Jun. 13, 2024

(30) Foreign Application Priority Data
Jun. 17, 2023 (TW) 112122828

(51) Int. Cl. H04W 52/02; H04L 1/00

(52) U.S. Cl. CPC H04W 52/0235; H04L 1/0036; H04W 52/0248

(57) ABSTRACT

A wireless receiver device includes a decoder, a memory and a processor. The decoder is configured to decode a packet in a period of several symbols to obtain raw data. The memory is configured to temporarily store the raw data. The processor is configured to determine at least one non-idle symbol and at least one idle symbol from the symbols according to the number of data bits per symbol and the number of symbols corresponding to the packet. The processor accesses the memory to perform data parsing on the raw data in a period of the non-idle symbol, but enters an idle state so as not to access the memory in a period of the idle symbol.

### RELATED APPLICATIONS

This application claims priority to Taiwan Application Serial Number 112122828, filed Jun. 17, 2023, which is herein incorporated by reference.

### BACKGROUND

### Technical Field

The present disclosure relates to decoding and parsing of received packets, and more particularly to a wireless receiver device, a data processing method thereof, and a wireless communication system.

### Description of Related Art

For wireless communications, a transmission end usually encodes raw data to form a packet, and then a receiving end decodes the packet to restore the raw data. Usually, when receiving the packet, a decoder decodes the packet to obtain the raw data and writes the raw data to a memory. Then, a processor accesses the memory to obtain the raw data, and performs data parsing on the raw data. Under a condition in which the occurrence of memory writing events cannot be predicted, the processor needs to continuously access the memory to obtain the decoded raw data and cannot perform another task, resulting in work efficiency degradation and significant power consumption. Therefore, how to optimize the power consumption performance of wireless communication devices in processing received packets is one of the main goals in related industries.

### SUMMARY

One aspect of the present disclosure directs to a wireless receiver device which includes a decoder, a memory and a processor. The decoder is configured to decode a packet in a period of plural symbols to obtain raw data. The memory is configured to temporarily store the raw data. The processor is configured to determine at least one non-idle symbol and at least one idle symbol from the symbols according to the number of data bits per symbol and the number of symbols corresponding to the packet. The processor accesses the memory to perform data parsing on the raw data in a period of the non-idle symbol, and enters an idle state so as not to access the memory in a period of the idle symbol.

Another aspect of the present disclosure directs to a data processing method which is adapted to a wireless receiver device and includes: decoding a packet in a period of a plurality of symbols to obtain raw data; temporarily storing the raw data to a memory; and determining at least one non-idle symbol and at least one idle symbol from the plurality of symbols according to the number of data bits per symbol and the number of symbols corresponding to the packet, and accessing the memory to perform data parsing on the raw data in a period of the at least one non-idle symbol, and entering an idle state so as not to access the memory in a period of the at least one idle symbol.

Another aspect of the present disclosure directs to a wireless communication system which includes a wireless transmitter device and a wireless receiver device, in which the wireless transmitter device is configured to transmit a packet, and the wireless receiver device is configured to receive the packet via a wireless channel. The wireless receiver device includes a decoder, a memory and a processor. The decoder is configured to decode a packet in a period of plural symbols to obtain raw data. The memory is configured to temporarily store the raw data. The processor is configured to determine at least one non-idle symbol and at least one idle symbol from the symbols according to the number of data bits per symbol and the number of symbols corresponding to the packet. The processor accesses the memory to perform data parsing on the raw data in a period of the non-idle symbol, and enters an idle state so as not to access the memory in a period of the idle symbol.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiment of the present disclosure.

FIG. 2 is a circuit block diagram of a wireless receiver device in accordance with some embodiment of the present disclosure.

FIG. 3 is an example of packet decoding using the wireless receiver device in FIG. 2.

FIG. 4 is a schematic flowchart of a symbol state determination method in accordance with some embodiment of the present disclosure.

FIGS. 5-6 are examples of the status of a processor at different numbers of data bits per symbol and the same number of symbols.

FIG. 7 is a schematic flowchart of a data processing method in accordance with some embodiment of the present disclosure.

### DETAILED DESCRIPTION

The detailed explanation of the present disclosure is described as following. The described preferred embodiments are presented for purposes of illustrations and description, and they are not intended to limit the scope of the present disclosure.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, and High Efficiency (HE) modes, in which the HT modes, the VHT modes, and the HE modes respectively correspond to various generations of wireless local area networks (WLANs) such as Wi-Fi 4, Wi-Fi 5, and Wi-Fi 6. More transmission modes are usable for a wireless transceiver device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

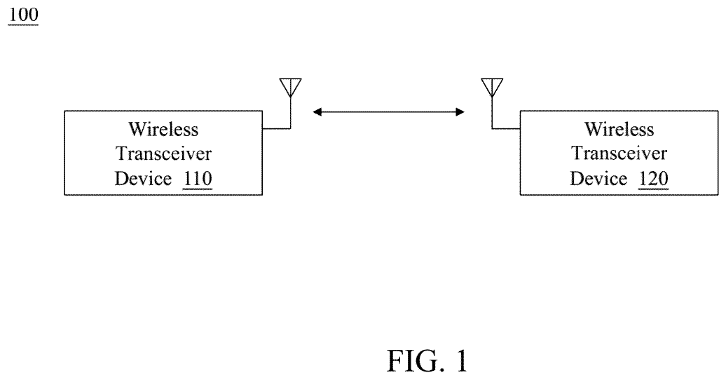

FIG. 1 is a schematic diagram of a wireless communication system 100 in accordance with some embodiment of the present disclosure. The communication technology applied in the wireless communication system 100 may be, for example, a wireless area network communication technology in accordance with the IEEE 802.11 standard (including IEEE 802.11ac, IEEE 802.11ax, etc.), and/or another applicable wireless communication technology. The wireless communication system 100 includes wireless transceiver devices 110 and 120 which are communicatively connected via a wireless channel. The wireless transceiver devices 110 and 120 may have functions of transmitting and receiving data packets. For example, in a scenario where the wireless transceiver device 110 transmits packets to the wireless transceiver device 120 via the wireless channel, the wireless transceiver devices 110 and 120 may also be referred to as a wireless transmitter device and a wireless receiver device, respectively.

The wireless channel in the wireless communication system 100 may support multiple-input multiple-output (MIMO), multiple-input single-output (MISO), single-input multiple-output (SIMO), and/or single-input single-output (SISO) transmissions between the wireless transceiver devices 110 and 120. Each of the wireless transceiver devices 110 and 120 may represent a variety of different implementations, including but not limited to mobile wireless transceiver devices such as stations (STAs), laptops, mobile phones, tablet computers, and access points (APs), and/or fixed wireless transceiver devices such as routers, switches, computer devices, server devices, and workstations.

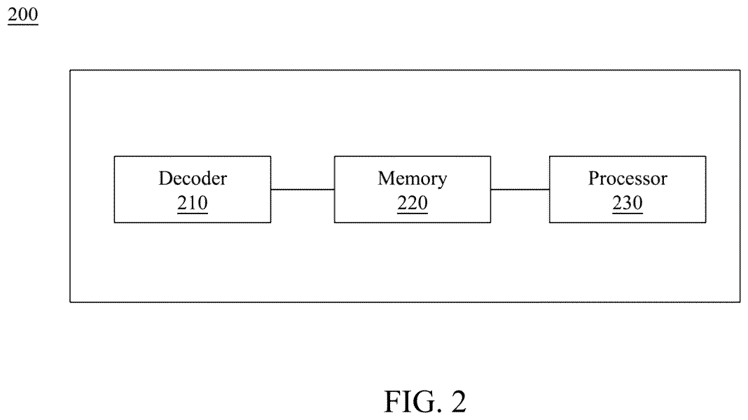

FIG. 2 is a schematic block diagram of a wireless receiver device 200 in accordance with some embodiments of the present disclosure. The wireless receiver device 200 may be the wireless transceiver device 110 and/or the wireless transceiver device 120 in FIG. 1. The wireless receiver device 200 includes a decoder 210, a memory 220 and a processor 230. The decoder 210 is configured to decode a received packet to obtain raw data. According to the coding technology applied in the wireless communication system, the decoder 210 may be, for example, a convolutional decoder, a trellis decoder, a Viterbi decoder, and/or a turbo decoder, but is not limited thereto. For example, if the wireless receiver device 200 is used in a WLAN communication system, the decoder 210 may be a Viterbi decoder.

The memory 220 is coupled to decoder 210, which may be configured to temporarily store the raw data obtained after decoding the packet by the decoder 210. The memory 220 may be a data memory (DMEM), a static random access memory (SRAM), or another memory suitable for temporarily storing the raw data.

The processor 230 is coupled to the memory 220, which may access the memory 220 to obtain the raw data temporarily stored in the memory 220, and may perform data parsing on the obtained raw data. The processor 230 may be, for example, a conventional processor, a multi-core processor, a digital signal processor (DSP), a microprocessor, or an application-specific integrated circuit (ASIC), but is not limited thereto.

The decoder 210 decodes the packet to obtain the raw data during plural symbols. Specifically, during each symbol, the decoder 210 decodes a corresponding segment in the packet to obtain the raw data in the number of data bits per symbol N_{DBPS}. When the number of remaining bits rest_bits of the raw data decoded by the decoder 210 and not yet written to the memory 220 is greater than the bit number threshold T_{bits}, the decoder 210 may write a part of the raw data to the memory 220 for the processor 230 to perform data parsing. In particular, according to the performance characteristics of the processor 230 (such as clock rate), when the number of remaining bits rest_bits of the raw data is greater than the bit number threshold T_{bits} for the first time, the decoder 210 writes one K-bit source data string to the memory 220. Then, before the last symbol, as long as the number of remaining bits rest_bits of the raw data increases to be greater than the bit number threshold T_{bits} for other than the first time, the decoder 210 writes two K-bit source data strings to the memory 220. During the last symbol, the decoder 210 writes all raw data not yet written to the memory 220 to the memory 220.

Further, when the decoder 210 decodes the packet during plural symbols to obtain raw data and temporarily stores the raw data to the memory, the processor 230 determines non-idle symbols and idle symbols from these symbols according to the number of data bits per symbol N_{DBPS} corresponding to the packet and the number of symbols. During the period of each non-idle symbol, the processor 230 accesses the memory 220 to perform data parsing on the raw data. Oppositely, during the period of each idle symbol, the processor 230 enters an idle state without accessing the memory 220.

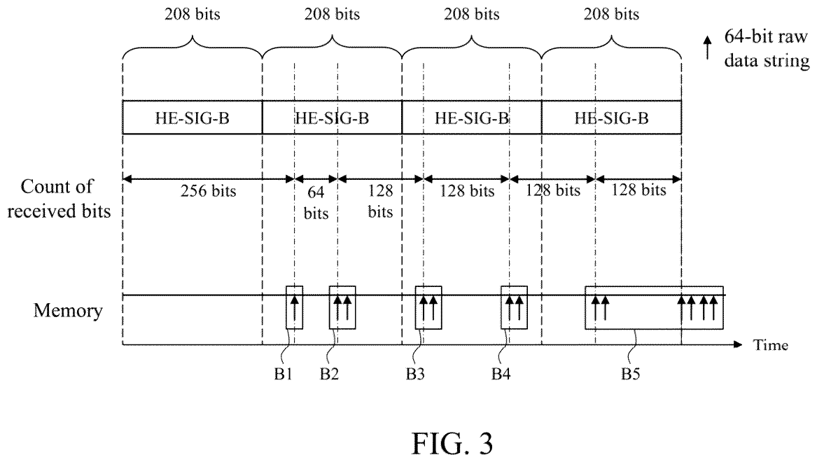

FIG. 3 is an example of packet decoding using the wireless receiver device 200 in FIG. 2. In this example, the wireless receiver device 200 is in an IEEE 802.11ax wireless area network to receive and decode a packet with an HE multi-user (MU) physical layer protocol data unit (PPDU) format (also referred to as HE MU PPDU) and a modulation and coding scheme (MCS) index of 5, and the decoder 210 performs Viterbi decoding on a HE-SIG-B field in the received packet and writes to the memory 220 in 64-bit strings, in which the HE-SIG-B field corresponds to four orthogonal frequency division multiplexing (OFDM) symbols (hereinafter referred to as OFDM symbols). During the first OFDM symbol, the decoder 210 decodes the first segment of the HE-SIG-B field in the packet. The number of remaining bits rest_bits of the raw data increases to 208 and does not exceed 256, and therefore the decoder 210 does not write any 64-bit raw data string to the memory 220, i.e., no data write event occurs in the memory 220. During the second OFDM symbol, the decoder 210 decodes the second segment of the HE-SIG-B field in the packet, such that the number of remaining bits rest_bits increases to 416 that exceeds 256, and therefore the decoder 210 writes a 64-bit raw data string to the memory 220 (as shown in an arrow in Block B1). After writing a 64-bit string, the number of remaining bits rest_bits decreases to 352 that still exceeds 256, and thus the decoder 210 then writes two more 64-bit raw data strings to the memory 220 (as shown in two arrows in Block B2). During the third OFDM symbol, the decoder 210 decodes the third segment of the HE-SIG-B field in the packet, such that the number of remaining bits rest_bits increases to 432 that exceeds 256, and thus the decoder 210 writes two 64-bit raw data strings to the memory 220 (as shown in two arrows in block B3). After writing two 64-bit raw data strings, the number of remaining bits rest_bits is 304 that still exceeds 256, and thus the decoder 210 then writes two more 64-bit raw data strings to the memory 220 (as shown in two arrows in block B4). During the fourth OFDM symbol, the decoder 210 decodes the fourth segment of the HE-SIG-B field in the packet, and then the raw data with the number of remaining bits rest_bits of 384 are divided into six 64-bit source data strings to be written to the memory 220 (as shown in 6 arrows in block B5).

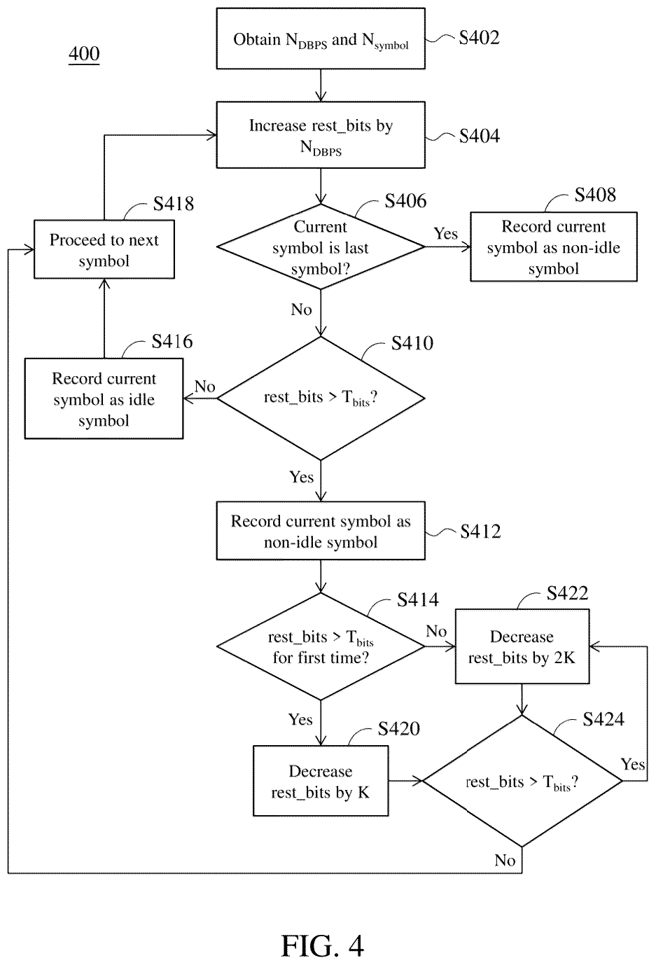

FIG. 4 is a schematic flowchart of a symbol state determination method 400 in accordance with some embodiments of the present disclosure. The symbol state determination method 400 may be used in the wireless receiver device 200 in FIG. 2 or another suitable wireless receiver device. For example, in an example of the wireless receiver device 200, the symbol state determination method 400 may be performed by the processor 230.

In the symbol state determination method 400, Operation S402 is performed to obtain the number of data bits per symbol N_{DBPS} and the number of symbols N_{symbol}, and to initiate the number of remaining bits rest_bits and a symbol sequence order i as 0 and 1, respectively. Next, Operation S404 is performed to increase the number of remaining bits rest_bits of the raw data by the number of data bits per symbol N_{DBPS}. After that, Operation S406 is performed to determine whether the current symbol is the last symbol, i.e., whether the symbol sequence order i is equal to the number of symbols N_{symbol}. If yes, Operation S408 is performed to label the current symbol (i.e., the i^{th} symbol) as a non-idle symbol, and the symbol state determination method 400 finishes. Oppositely, if the current symbol is not the last symbol, Operation S410 is performed to determine whether the number of remaining bits rest_bits of the raw data is greater than the bit number threshold T_{bits}. If the determination result of Operation S410 is that the number of remaining bits rest_bits of the raw data is greater than the bit number threshold T_{bits}, Operation S412 is performed to label that the current symbol (i.e., the i^{th} symbol) as a non-idle symbol, and then Operation S414 is performed to determine whether the number of remaining bits rest_bits of the raw data is greater than the bit number threshold T_{bits} for the first time. Oppositely, if the determination result of Operation S410 is that the number of remaining bits rest_bits of the raw data is not greater than the bit number threshold T_{bits}, Operation S416 is performed to record that the current symbol (i.e., the i^{th} symbol) as an idle symbol, and then Operation S418 is performed to proceed to the next symbol (i.e., the symbol sequence order i incremented by 1), and return to Operation S404 for processing on the next symbol.

If the determination result of Operation S414 is that the number of remaining bits rest_bits of the raw data is greater than the threshold bits T_{bits} for the first time, Operation S420 is performed to subtract the number of remaining bits rest_bits of the raw data by the number of bits of one K-bit raw data string (i.e., rest_bits-K). Oppositely, if the determination result of Operation S414 is that the number of remaining bits rest_bits of the raw data is not greater than the bit number threshold T_{bits} for the first time, then Operation S422 is followed to subtract the number of bits of two K-bit raw data strings from the number of remaining bits rest_bits of the raw data (i.e., rest_bits-2K). After Operation S420 or S422, Operation S424 is followed to determine whether the number of remaining bits rest_bits of the raw data is greater than the bit threshold number T_{bits}. If the number of remaining bits rest_bits of the raw data is greater than the bit number threshold T_{bits}, Operation S422 is performed. Otherwise, Operation S418 is performed.

The bit number threshold T_{bits} and the number of bits K of the raw data strings in the symbol state determination method 400 may be adjusted according to software and hardware specifications and/or communication system specifications. In some embodiments, the bit number threshold T_{bits} is required to be greater than or equal to twice the number of bits K of the raw data strings, i.e. T_{bits}≥2K. In some embodiments, the bit number threshold T_{bits} and the number of bits K of the raw data strings are 256 and 64, respectively. In addition, some operations in the symbol state determination method 400 also correspond to the operations of the decoder and the memory; Operation S404 corresponds to decoding the i^{th} HE-SIG-B packet by the decoder, Operation S408 corresponds to the event in which the decoder writes all remaining data to the memory at the end of the last symbol, Operation S420 corresponds to the event in which the decoder writes one K-bit raw data string to the memory, and Operation S422 corresponds to the event in which the decoder writes two K-bit raw data strings to the memory.

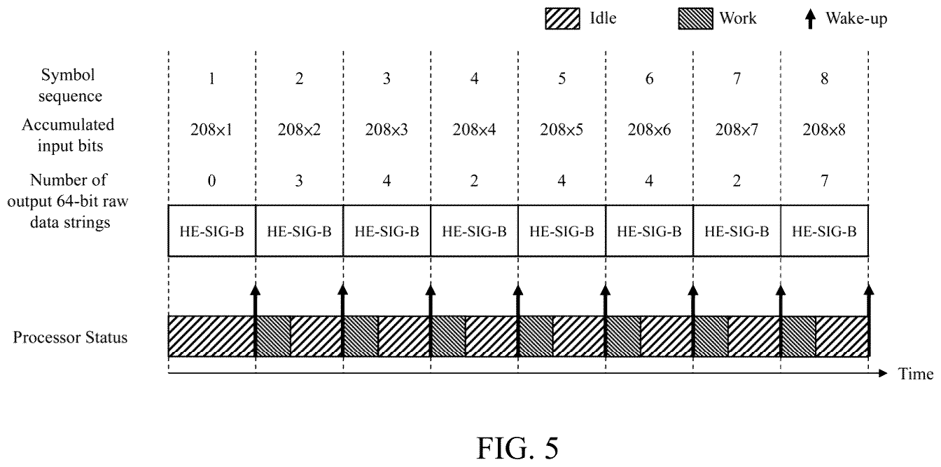

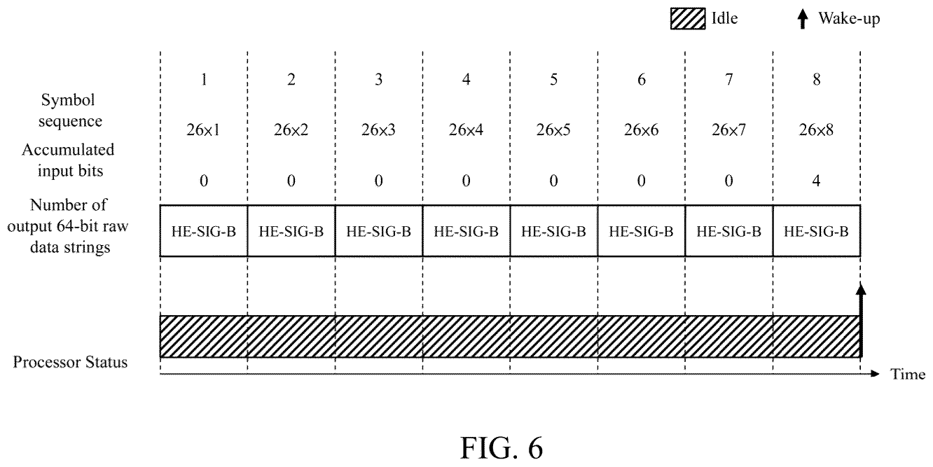

FIGS. 5 and 6 are examples of the status of the processor under different numbers of data bits per symbol N_{DBPS} and the same number of symbols N_{symbol}, in which the bit number threshold T_{bits} and the number of bits K of the raw data strings are 256 and 64, respectively. In the example in FIG. 5, the number of data bits per symbol N_{DBPS} and the number of symbols N_{symbol} are 208 and 8, respectively. As can be seen from the content shown in FIG. 5, during the period of the first symbol, the decoder does not write any 64-bit raw data string to the memory, and thus the processor wakes up to enter a wake-up state (work state) during each of the 2^{nd} to 8^{th} symbols. In contrast, in the example in FIG. 6, the number of data bits per symbol N_{DBPS} and the number of symbols N_{symbol} are 28 and 8, respectively. As can be seen from the content shown in FIG. 6, the decoder does not write any 64-bit raw data string to the memory during the period of the 1^{st} to 7^{th} symbols; during the 8^{th} symbol, the decoder writes all unwritten bit data strings to the memory, and thus the processor wakes up to enter the wake-up state only during the 8^{th} symbol.

Tables 1 and 2 are respective statistical tables of the number of idle symbols and the percentage of idle symbols corresponding to the number of data bits per symbol N_{DBPS} of 13, 26, 52, 78, 104, 156, and 208, and the number of symbols N_{symbol} of 1 to 20 at the bit number threshold T_{bits} and the number of bits K of the raw data strings respectively of 256 and 64. As can be seen from Table 1, in a condition in which the number of symbols N_{symbol} is at least 2, at least one idle symbol is present, and the smaller number of data bits per symbol N_{DBPS} may correspond to more idle symbols at the same number of symbols N_{symbol}. In addition, as can be seen from Table 2, the larger number of symbols N_{symbol} and the smaller the number of symbols N_{symbol} correspond to a larger percentage of idle symbols, which can reduce more power consumption and increase more usage efficiency of the processor. Further, in a system configuration in which the number of data bits per second N_{DBPS} is 13 or 26 and the number of symbols N_{symbol} is at least 2, the percentage of idle symbols is at least 50%, and can be higher to 80% to 95%, representing that the processor is in the idle state during up to 80% to 95% of the time.

TABLE 1

| T_{bits} = 256 | | Number of symbol bits per symbol N_{DBPS} | | | | | | |
|---|---|---|---|---|---|---|---|---|
| K = 64 | | 13 | 26 | 52 | 78 | 104 | 156 | 208 |
| Number of | 1 | 0 | 0 | 0 | 0 | 0 | 0 | 0 |
| symbols | 2 | 1 | 1 | 1 | 1 | 1 | 1 | 1 |
| N_{symbol} | 3 | 2 | 2 | 2 | 2 | 2 | 1 | 1 |
| | 4 | 3 | 3 | 3 | 3 | 2 | 1 | 1 |
| | 5 | 4 | 4 | 4 | 3 | 2 | 1 | 1 |
| | 6 | 5 | 5 | 4 | 3 | 2 | 1 | 1 |
| | 7 | 6 | 6 | 5 | 3 | 2 | 1 | 1 |
| | 8 | 7 | 7 | 5 | 4 | 2 | 1 | 1 |
| | 9 | 8 | 8 | 6 | 4 | 3 | 1 | 1 |
| | 10 | 9 | 9 | 6 | 5 | 3 | 1 | 1 |
| | 11 | 10 | 9 | 7 | 5 | 3 | 1 | 1 |
| | 12 | 11 | 10 | 8 | 5 | 3 | 1 | 1 |
| | 13 | 12 | 11 | 8 | 6 | 3 | 1 | 1 |
| | 14 | 13 | 11 | 9 | 6 | 3 | 1 | 1 |
| | 15 | 14 | 12 | 9 | 6 | 4 | 1 | 1 |
| | 16 | 15 | 13 | 10 | 7 | 4 | 1 | 1 |
| | 17 | 16 | 14 | 11 | 7 | 4 | 1 | 1 |
| | 18 | 17 | 15 | 11 | 8 | 4 | 1 | 1 |
| | 19 | 18 | 15 | 12 | 8 | 4 | 1 | 1 |
| | 20 | 19 | 16 | 12 | 8 | 5 | 1 | 1 |

TABLE 2

| T_{bits} = 256 | | Number of data bits per symbol N_{DBPS} | | | | | | |
|---|---|---|---|---|---|---|---|---|
| K = 64 | | 13 | 26 | 52 | 78 | 104 | 156 | 208 |
| Number of | 1 | 0.00% | 0.00% | 0.00% | 0.00% | 0.00% | 0.00% | 0.00% |
| symbols | 2 | 50.00% | 50.00% | 50.00% | 50.00% | 50.00% | 50.00% | 50.00% |
| N_{symbol} | 3 | 66.67% | 66.67% | 66.67% | 66.67% | 66.67% | 33.33% | 33.33% |
| | 4 | 75.00% | 75.00% | 75.00% | 75.00% | 50.00% | 25.00% | 25.00% |
| | 5 | 80.00% | 80.00% | 80.00% | 60.00% | 40.00% | 20.00% | 20.00% |
| | 6 | 83.33% | 83.33% | 66.67% | 50.00% | 33.33% | 16.67% | 16.67% |
| | 7 | 85.71% | 85.71% | 71.43% | 42.86% | 28.57% | 14.29% | 14.29% |
| | 8 | 87.50% | 87.50% | 62.50% | 50.00% | 25.00% | 12.50% | 12.50% |
| | 9 | 88.89% | 88.89% | 66.67% | 44.44% | 33.33% | 11.11% | 11.11% |
| | 10 | 90.00% | 90.00% | 60.00% | 50.00% | 30.00% | 10.00% | 10.00% |
| | 11 | 90.91% | 81.82% | 63.64% | 45.45% | 27.27% | 9.09% | 9.09% |
| | 12 | 91.67% | 83.33% | 66.67% | 41.67% | 25.00% | 8.33% | 8.33% |
| | 13 | 92.31% | 84.62% | 61.54% | 46.15% | 23.08% | 7.69% | 7.69% |
| | 14 | 92.86% | 78.57% | 64.29% | 42.86% | 21.43% | 7.14% | 7.14% |
| | 15 | 93.33% | 80.00% | 60.00% | 40.00% | 26.67% | 6.67% | 6.67% |
| | 16 | 93.75% | 81.25% | 62.50% | 43.75% | 25.00% | 6.25% | 6.25% |
| | 17 | 94.12% | 82.35% | 64.71% | 41.18% | 23.53% | 5.88% | 5.88% |
| | 18 | 94.44% | 83.33% | 61.11% | 44.44% | 22.22% | 5.56% | 5.56% |
| | 19 | 94.74% | 78.95% | 63.16% | 42.11% | 21.05% | 5.26% | 5.26% |
| | 20 | 95.00% | 80.00% | 60.00% | 40.00% | 25.00% | 5.00% | 5.00% |

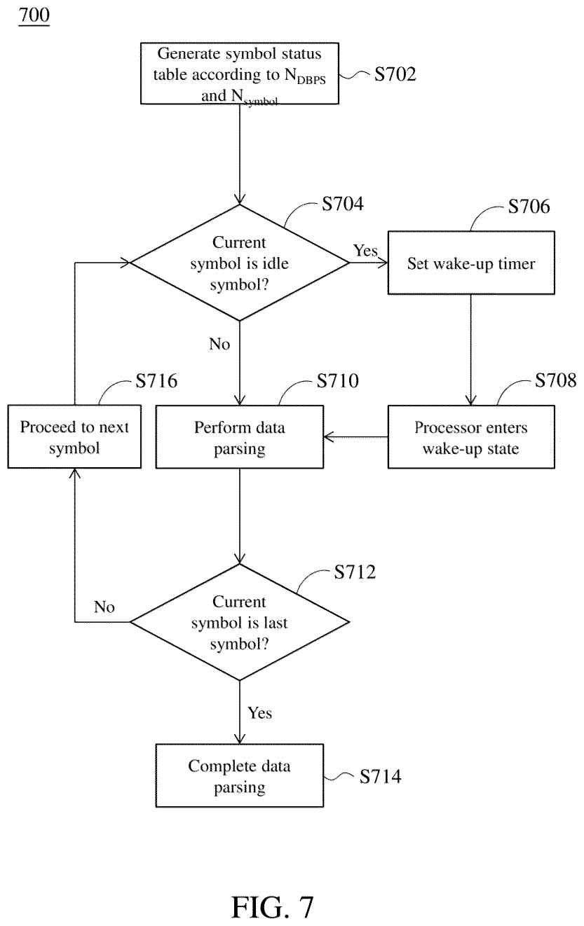

FIG. 7 is a schematic flowchart of a data processing method 700 in accordance with some embodiments of the present disclosure. The data processing method 700 may be used in the wireless receiver device 200 in FIG. 2 or another suitable wireless receiver device. For example, in an example of the wireless receiver device 200, the data processing method 700 may be performed by the processor 230.

In the data processing method 700, first Operation S702 is performed to generate a symbol state list according to the number of data bits per symbol N_{DBPS} and the number of symbols N_{symbol}. The symbol state list includes information about whether each symbol is an idle symbol or not. In addition, the symbol state list may be generated by performing the symbol state determination method 400. In performing the symbol state determination method 400, each symbol will be determined whether it is an idle symbol or not (i.e., whether it is an idle symbol or a non-idle symbol). For example, if the number of data bits per symbol N_{DBPS} and the number of symbols N_{symbol} are 208 and 8, respectively, then by performing the symbol state determination method 400, it can be determined that the first symbol is an idle symbol while the 2^{nd} to 8^{th} symbols are non-idle symbols, and thus the obtained symbol state list can be as shown in Table 3 below.

TABLE 3

| Symbol sequence | 1 | 2 | 3 | 4 | 5 | 6 | 7 | 8 |
|---|---|---|---|---|---|---|---|---|
| Idle symbol (I)/ | I | N | N | N | N | N | N | N |
| non-idle symbol (N) | | | | | | | | |

Next, Operation S704 is performed to determine whether the current symbol is idle according to the symbol state list. If yes, Operation S706 is performed to enter the idle state so as not to access the memory, and a wake-up timer is set to determine the time at which the processor wakes up from the idle state according to the order in which the next non-idle symbol appears. When the wake-up timer is timeout, Operation S708 is performed, in which the processor enters the wake-up state, and then Operation S710 is perform to access the memory to obtain the raw data strings to perform data parsing. On the contrary, if the determination result of Operation S704 is that the current symbol is a non-idle symbol, Operation S710 is performed directly. After Operation S710 is done, Operation S712 is performed to determine whether the current symbol is the last symbol according to the symbol state list. If the current symbol is determined to be the last symbol, Operation S714 is performed, in which the processor completes data parsing. On the contrary, if the current symbol is determined not to be the last symbol, Operation S716 is performed to enter the next symbol and return to Operation S704.

As can be seen from the above description, the embodiments of the present disclosure can predict whether there is an event in which a decoded bit data string is written to the memory during each symbol, and determine whether the processor enters the wake up state to perform data parsing on the bit data string stored in the memory or enters the idle state according to the prediction results. Therefore, in comparison with the conventional processing method, in the embodiments of the present disclosure, the processor enters the idle state without accessing the memory when there is no event of writing to the memory, until there is a decoded raw data written to the memory for the processor to access the memory to perform data parsing, thereby achieving the efficacy of saving power consumption.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A wireless receiver device, comprising:
a decoder configured to decode a packet in a period of a plurality of symbols to obtain raw data;
a memory configured to temporarily store the raw data; and
a processor configured to determine at least one non-idle symbol and at least one idle symbol from the plurality of symbols according to the number of data bits per symbol and the number of symbols corresponding to the packet;
wherein the processor accesses the memory to perform data parsing on the raw data in a period of the at least one non-idle symbol, and wherein the processor enters an idle state so as not to access the memory in a period of the at least one idle symbol.

2. The wireless receiver device of claim 1, wherein the decoder is a Viterbi decoder.

3. The wireless receiver device of claim 1, wherein the decoder is configured to perform the following operations on the raw data:
writing one raw data string of the raw data to the memory when the number of remaining bits of the raw data is greater than a bit number threshold for the first time;
writing two raw data strings of the raw data to the memory when the number of remaining bits of the raw data is not greater than the bit number threshold for the first time; and
writing remaining data of the raw data to the memory in a period of a last symbol of the plurality of symbols.

4. The wireless receiver device of claim 3, wherein the number of bits of each of the plurality of the raw data strings is 64, and wherein the bit number threshold is 256.

5. The wireless receiver device of claim 1, wherein the number of data bits per symbol is 13 or 26.

6. The wireless receiver device of claim 1, wherein the processor is configured to generate a symbol state list according to the number of data bits per symbol and the number of symbols, and wherein the symbol state list comprises state information about whether each of the plurality of symbols is an idle symbol.

7. The wireless receiver device of claim 6, wherein the processor is configured to set a wake-up timer according to the symbol state list when entering the idle state, and wherein the processor enters a wake-up state when the wake-up timer is timeout.

8. A data processing method adapted to a wireless receiver device, the data processing method comprising:
decoding a packet in a period of a plurality of symbols to obtain raw data;
temporarily storing the raw data to a memory; and
determining at least one non-idle symbol and at least one idle symbol from the plurality of symbols according to the number of data bits per symbol and the number of symbols corresponding to the packet, and accessing the memory to perform data parsing on the raw data in a period of the at least one non-idle symbol, and entering an idle state so as not to access the memory in a period of the at least one idle symbol.

9. The data processing method of claim 8, wherein temporarily storing the raw data to the memory comprising:
writing one raw data string of the raw data to the memory when the number of remaining bits of the raw data is greater than a bit number threshold for the first time;
writing two raw data strings of the raw data to the memory when the number of remaining bits of the raw data is not greater than the bit number threshold for the first time; and
writing remaining data of the raw data to the memory in a period of a last symbol of the plurality of symbols.

10. The data processing method of claim 9, wherein the number of bits of each of the plurality of raw data strings is 64, and wherein the bit number threshold is 256.

11. The data processing method of claim 9, wherein the number of data bits per symbol is 13 or 26.

12. The data processing method of claim 8, further comprising:
generating a symbol state list according to the number of data bits per symbol and the number of symbols, wherein the symbol state list comprises state information about whether each of the plurality of symbols is an idle symbol; and
setting a wake-up timer according to the symbol state list when entering the idle state, and entering a wake-up state when the wake-up timer is timeout.

13. A wireless communication system, comprising:
a wireless transmitter device configured to transmit a packet; and
a wireless receiver device configured to receive the packet via a wireless channel, the wireless receiver device comprising:
a decoder configured to decode the packet in a period of a plurality of symbols to obtain raw data;
a memory configured to temporarily store the raw data; and
a processor configured to determine at least one non-idle symbol and at least one idle symbol from the plurality of symbols according to the number of data bits per symbol and the number of symbols corresponding to the packet;
wherein the processor accesses the memory to perform data parsing on the raw data in a period of the at least one non-idle symbol, and wherein the processor enters an idle state so as not to access the memory in a period of the at least one idle symbol.

14. The wireless communication system of claim 13, wherein the packet comprises a High Efficiency (HE) multi-user (MU) physical layer protocol data unit (PPDU) format.

15. The wireless communication system of claim 13, wherein the decoder is a Viterbi decoder.

16. The wireless communication system of claim 13, wherein the decoder is configured to perform the following operations on the raw data:
writing one raw data string of the raw data to the memory when the number of remaining bits of the raw data is greater than a bit number threshold for the first time;
writing two raw data strings of the raw data to the memory when the number of remaining bits of the raw data is not greater than the bit number threshold for the first time; and
writing remaining data of the raw data to the memory in a period of a last symbol of the plurality of symbols.

17. The wireless communication system of claim 16, wherein the number of bits of each of the plurality of raw data strings is 64, and wherein the bit number threshold is 256.

18. The wireless communication system of claim 16, wherein the number of data bits per symbol is 13 of 26.

19. The wireless communication system of claim 13, wherein the processor is configured to generate a symbol state list according to the number of data bits per symbol and the number of symbols, and wherein the symbol state list comprises state information about whether each of the plurality of symbols is an idle symbol.

20. The wireless communication system of claim 19, wherein the processor is configured to set a wake-up timer according to the symbol state list when entering the idle state, and wherein the processor enters a wake-up state when the wake-up timer is timeout.
